(19) United States
(12) Patent Application Publication
(10) Pub. No.: US 2002/0174205 A1
(43) Pub. Date: Nov. 21, 2002

(54) Method and apparatus to deliver personalized travel data

(76) Inventor: Susan Nakashima, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/861,299

(22) Filed: May 18, 2001

(51) Int. Cl. G06F 7/00

(52) U.S. Cl. 709/221

(57) ABSTRACT

Personalized travel diaries (travel information) can be requested via the Internet and delivered to an output device owned, operated or controlled by an air carrier or other common carrier, which can then print out the information as a travel aid. Content information that can be electronically delivered can also be selected on the basis of user profile information.

### BACKGROUND OF THE INVENTION

Reference is made to U.S. patent application Ser. No. ______ (Docket No. 10005370), “Personal Digital Assistant With Streaming Information Display”, to Kevin G. Currans, et al., filed on the same day herewith, assigned to the same assignee, and which may contain related information.

The number of people who travel by one or more common carriers (airlines, rail and bus service) continues to increase each year with no end in sight. Among all common carriers, airlines have experienced the greatest increase in the number of travelers. Low airfares and industry competition have made air travel the preferred way to travel even distances of only a few hundred miles.

Anyone who regularly travels by air however, has undoubtedly experienced, among other things, the frustration that accompanies flight delays, schedule changes, flight cancellations, over-bookings, gate changes and other operational characteristics of many air carriers. Even when service is provided, e.g. flights are ostensibly on time and a seat obtained, air travel can be, and usually is, monotonous as there are few activities that a traveler can participate in when waiting in an airport or sitting on an airplane.

In an age of ubiquitous wireless communications devices and instant data network communications that are provided via the Internet, a method and apparatus by which travel-related information could be provided to travelers might prove to be a useful travel aid. The provision of entertainment material for the traveler's use or consumption while traveling might also prove to be valuable.

### SUMMARY OF THE INVENTION

There is provided a method and system for providing travel-related information to a traveler. The information that is provided is keyed to (associated with) at least part of the traveler's itinerary, on an individualized basis, such as the traveler's destination or the carrier that the traveler is using.

The term “travel-related information” includes, but is not limited to: scheduled services provided by one or more common carriers, including service interruptions, delays, cancellations and other data; local time at one or more of the traveler's destination(s); local weather conditions; ground transport (car rental); restaurants; housing and rental accommodations; newspapers and other publications or periodicals, such as that collected by the

### BRIEF DESCRIPTION OF THE DRAWINGS

FIG. 1 shows a simplified block diagram of a system by which travel-related data can be collected by a computer or personal digital assistant using a data network through which travel-related data can be collected. Using the network, collected data can be sent from a centralized computer or server to an output device (for printing and/or display) remotely located from the computer.

FIG. 2 shows a simplified flow chart depicting steps of a method by which travel-related data is collected at a computer and sent to a remotely located printer device.

### DETAILED DESCRIPTION OF THE PREFERRED EMBODIMENT

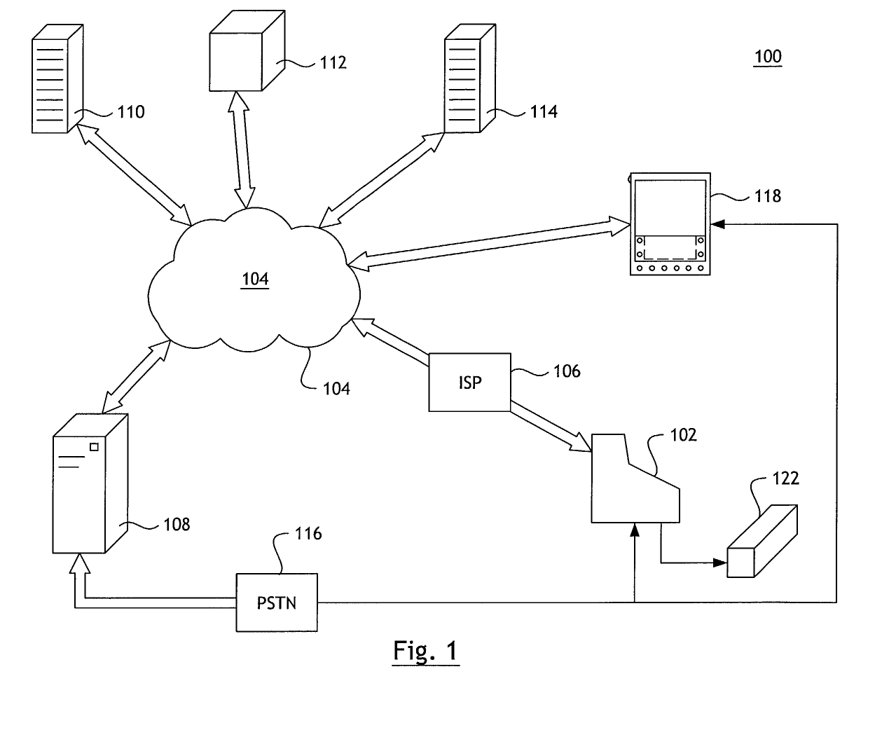

FIG. 1 depicts a simplified block diagram of a system 100 by which personalized travel diaries, i.e. personalized travel-related data, can be centrally collected and then be sent to a subscriber for printing or viewing on either a personal computer (PC) or a personal digital assistant (PDA). The personalized travel data is sent to a subscriber using a data network such as the Internet. Once the data is received, it can be printed or viewed at the subscriber's convenience.

The system provides a means by which a travel-information service provider, or a common carrier such as an airline, can quickly and inexpensively distribute up-to-date pertinent travel information (as well as other data and information as described below, all of which is considered to be travel related data and information for claim construction purposes) to individuals via a data network such as the Internet. The provision of travel information is preferably provided to individuals as a subscription service. Of particular significance is the fact that the travel information is particularized for at least part of the itinerary of a particular traveler. The information is custom-selected and customer formatted for ease of use. News and topical information, which can also be provided, can be limited to stories and/or topics of interest to the subscriber according to data in a user-profile data base.

By way of example, a person wishing to travel to a particular destination can request from the third party service provider such as an airline, the flight schedules of all airlines serving a particular destination from a particular origination. Flight numbers and departure and arrival times for the destination can be delivered via the Internet for printing or display. Data on hotels, rental cars, restaurants and the like can also be assembled by a remote server and sent to the traveler. Using the user-profile data, only restaurants serving particular types of food might be identified; hotels having rooms in a particular price range might only be identified. Newspapers or other printed material can also be collected and sent, excluding stories that are of no interest to the traveler.

The various kinds of travel information that can be distributed via the system depicted in FIG. 1 includes, but is not limited to, information related to: schedules of common carriers serving a traveler's destination or intermediate stops along the way; hotel and lodging accommodations in, around or proximate to the travelers destination; local shopping areas, local retailers, local entertainment or sporting events; local weather forecasts and climate related data; restaurants and other food purveyors. By using the system shown in FIG. 1, on-line editions of newspapers and periodical publications can also be downloaded (copied or collected, with appropriate intellectual property licensing) on-line and forwarded to a personal computer, server or other processor of an air carrier to which might be coupled a high-speed printer. In addition, advertising material from a downloaded publication, or from vendors and/or merchants or service providers (e.g. an airline) whose goods and/or services might be identified in the aforementioned stream of advertising information can also be sent to the PDA or printer for output. Airlines might include information about travel promotions or discounted airfares to other destinations that they serve or travel packages. For claim construction purposes, all of the foregoing advertising embodiments, as well as any other sort of commercial messages intended to be directed to a traveler, are considered to be equivalent embodiments under the rubric of “advertising data and information” or “advertising material.” When the advertising data and information, as well as any other non-advertising content information, is delivered to a PDA, it can be displayed (wholly or partly) thereon using the methodology disclosed in the aforementioned patent application for a “PERSONAL DIGITAL ASSISTANT WITH STREAMING INFORMATION DISPLAY” by Currans, et al. filed on the same day herewith and assigned to the Hewlett-Packard Company, the display methodologies of which are incorporated herein by reference. In the preferred embodiment, information is printed onto paper for the traveler's use, preferably on smaller-sized pages making the print out easier to handle in small spaces, such as on an airplane. Alternate output forms are described hereinafter.

In the preferred embodiment, an air carrier (or other common carrier) can receive information files that are collected by a travel information service provider, or by other information service providers such as the Hewlett-Packard Instant Delivery (HPID) service. HPID delivers the personalized travel information to a PC or printer owned or operated by the air carrier, preferably near an airline gate for instance, such that a printed copy of the travel-related data can be presented by the airline to the traveler. Alternate delivery schemes include sending the formatted travel information to a subscriber's personal computer 102 so that the subscriber can print the information locally at his or her own printer 122. Still other delivery schemes would include delivery to a personal digital assistant (PDA) 118, preferably configured to scroll information on a PDA as disclosed in the co-pending patent application for a PERSONAL DIGITAL ASSISTANT WITH STREAMING INFORMATION DISPLAY by Currans, et al, and assigned to the Hewlett-Packard Company, the teaching of a ticker-tape display on a PDA of which is incorporated by reference.

By scrolling information on a PDA, as taught in the aforementioned copending patent application, large amounts of information can be displayed on a small screen of a PDA. As shown in FIG. 1, a PDA provides an alternate display mechanism for the custom travel information collected by the server 108 from a variety of other Internet-linked servers 112, 114.

In addition to travel information, HPID can select news and information stories from a variety of on-line sources, while limiting the collected news and information to those that are of interest to a particular individual according to user-profile information kept in a user profile data file (not shown). By using the data stored in a user profile, HPID can select for printing only stories of interest to an individual. User profile data might include a subscriber's gender, profession or occupation, income level, recreational interests and the like. Using such data, HPID can pre-select only stories and advertising that might be of interest to a subscriber.

With respect to FIG. 1, an individual's personal computer 102 is coupled to the Internet 104 by an Internet Service Provider (ISP) 106, which provides Internet access to the subscriber's PC 102 via appropriate transmission media (DSL, cable modem, dial up P.O.T.S. or other) and computer hardware (modem) and software (inter alia, an Internet browser). By using an appropriate web browser, the personal computer can access servers or computers 108, 110, 112, 114 coupled to the Internet, including the server of a travel information provider 108. The travel information provider server 108 might be an HPID server (which also collects news and other information from on-line publications), but might also be two or more servers of a plethora of information providers including two or more servers of travel information providers.

Those skilled in the art will recognize that a “server” might be a single user PC as well as a distributed network of separate computers or work stations, which function together to provide Internet web site functionality. Computer networks and Internet communications protocol are not germane to the inventive concept disclosed and claimed herein.

In the preferred embodiment, the personal computer 102 provides data to the travel information provider server 108 that typically includes at least a portion of the itinerary, over which a person intends to travel. In the preferred embodiment the data is provided to the server via an Internet-enabled data transfer. In an alternate embodiment, travel itinerary information might be supplied to server 108 via the public telephone switched network using well-known telephone dual tone multi-frequency (DTMF) actuated menus and responses. In such an embodiment, a traveler might dial up a predetermined phone number and identify or provide travel information using the keypads of his or her telephone. Still other embodiments might employ voice recognition software by which a traveler's speech could be recognized, including relevant travel data spoken by the traveler to the server. For claim construction purposes, DTMF keypad inputs, Internet enabled data transfer or voice recognition technology are considered equivalent methods for the server 108 to received data for at least a portion of a traveler's itinerary.

In the preferred embodiment server 108 is accessed by its Internet URL. Upon logging onto the server 108, it presents an data input template web page into which data such as origination point, destination point, travel dates and travel times might be entered. A traveler might enter his or her origination city and at least one destination point to which he or she intends to travel or is en route or traveling to.

Upon gathering key travel-related data from a subscriber, the travel information provider server 108 typically queries the computers or servers 112, 114 of third parties, which might have data related to at least some part or aspect of a traveler's itinerary. Some servers 112, 114 that the travel information provider server 108 might interrogate include, but are not limited to servers of an air carrier 110 in order to obtain flight data, schedule changes and the like. Other servers 112, 114 that could be queried by the travel information provider server 108 for data useful to the traveler include computer servers for hoteliers (e.g. to obtain available rooms and rates) restaurateurs, (e.g., to obtain menu selections, directions, reservations, dress code) local chambers of commerce (e.g., to obtain local demographic data, commercial business in the area, etc.) sports franchises (to obtain game information, tickets or other sponsored events), local academic institutions, ground transportation providers such as taxis, busses or ground transport shuttle services, or tourism bureaus for one or more destinations to which the traveler intends to travel to. The travel information provider server 108 might also interrogate the servers of on-line newspapers and periodicals to obtain electronic versions of newspapers for the consumption of the subscriber (PC 102).

Upon collecting the various data that might be available on line, the server 108 can format the collected information for transmission and display. The preferred mechanism for transmitting collected travel information is via the Internet to either a PC or PDA for printing at or by an appropriate printer. In the case of a PDA, one or more “kiosks” or other facilities at airports, hotels, rail terminals and other similar facilities can provide either direct connections or infrared (IR) data links to PC modems or PDAs. Using a remotely located kiosk (a remote terminal facility), at an airport for example, a traveler might download flight schedules, including late changes, cancellations or delays; select one or more flights or make flight changes by way of the PDA input pad, then, upload the flight changes to the air carrier by data carried on an IR link from an airport kiosk. The display of travel-related information can therefore take place on the PDA screen or via a printed output. Other information that can be “displayed” include electronic tickets, which could be “issued” by data passed back to the air carrier upon which a traveler intends to fly from either the PDA directly or the server 108 and made available to the gate agent, at a gate adjacent to a kiosk where the arrangements were made by the traveler for example. Alternatively, hard-copy tickets could be printed from a kiosk-located printer for use by the traveler. Car rentals and hotel reservations could also be made and confirmed in the same fashion, as well as provided to the traveler from printers on-board an airplane. The foregoing output types are, for claim construction purposes, considered to be equivalent forms of output that is “displayed.”

In addition to sending travel-related data, the system disclosed in FIG. 1 could also be used to create secure “keys” for use by the traveler at the airport or hotel. A secure “key” could take the form of a unique encrypted character string, output as an IR signal from the traveler's PDA, which when received by an IR detector “lock” would either open a gate or signal a gate agent that the holder of the PDA was a duly ticketed passenger. By out pulsing a secret code in infrared, detectable by IR detectors at boarding gates, the PDA thereby takes on the functionality similar to a remote keyless entry key fob used with automobiles. Such a signal from the PDA could also be used to open hotel rooms by providing to the PDA a secret code uniquely correlated to the hotel room rented by the traveler. Alternate embodiments would of course using programmers driven by the PDA to program the ubiquitous magnetic key cards now commonly used by hoteliers instead of physical keys.

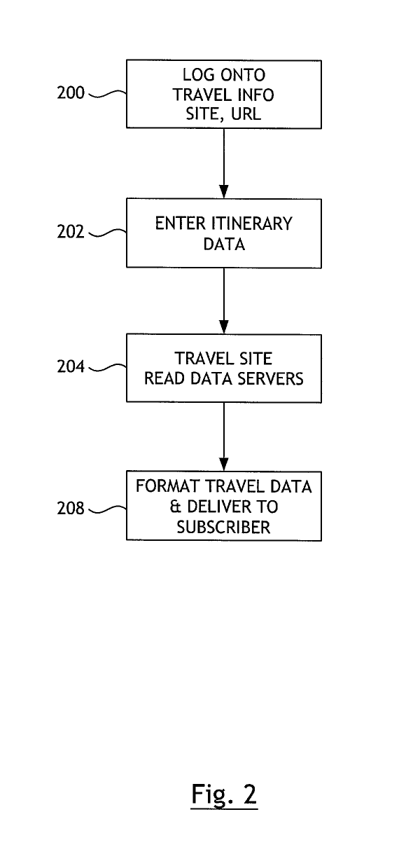

FIG. 2 shows a simplified block diagram of exemplary steps of the method of the preferred embodiment by which customized travel related data and information is collected.

In step 200, a prospective travel logs onto or links to the web site of a travel information provider. Once logged onto the pertinent web page, key data is supplied by the traveler to the server 108 in step 202 such that server 108 can thereafter act to obtain data from various servers 110, 112, 114 coupled to server 108 through the Internet 104 as shown in step 204.

Once communications with other servers 110, 112, and 114 is established via the Internet 104, pertinent data can be read from the servers 110, 112 and 114 by the travel information server 108 in step 206. Upon collecting data, the server 108 formats responsive information for transmission to the subscribes PC, PDA or other display mechanism and returns the data in step 208 to a particular destination computer (102), processor, server or printer (122), PDA 118 via the Internet, or perhaps by way of a communications link through the public switched telephone network 116 and associated telephone lines 120.

By automatically collecting pertinent travel information via the Internet, which can be electronically delivered to either a carrier or to an individual, all forms of travel might be made more enjoyable and less unnerving, particularly by those who require up to the minute updates on a travel services. Other services described above can be provided to travelers on an on-the-fly basis as well.

What is claimed is:

1. A method for delivering information associated with at least a portion of the itinerary of a traveler comprised of the steps of:
receiving at a first computer coupled to a data network, at least a portion of a travel itinerary for a traveler;
said computer generating a first set of travel data, said travel data being related to and particularly associated with, at least one of portion of said travel itinerary for said traveler;
said computer transmitting said first set of travel data, to a display device via said data network, said display device being remotely located from said first computer.

2. The method of claim 1 wherein said step of generating said first set of travel data includes the step of:
said computer obtaining, from at least one common carrier, schedule information for services offered by said common carrier that are pertinent to said travel itinerary for said traveler.

3. The method of claim 1 wherein said step of generating said first set of travel data includes the step of:
said computer obtaining from at least one accommodations provider, accommodations services that are offered by said accommodations provider and that are pertinent to said travel itinerary.

4. The method of claim 1 wherein said step of generating a first set of travel data includes the step of:
said computer obtaining meteorological data for at least a portion of said travel itinerary.

5. The method of claim 1 wherein said step of, receiving at a first computer coupled to a data network, at least a portion of a travel itinerary, is comprised of the steps of:
receiving at said first computer a geographical destination for a traveler who is traveling to said destination via service provided by at least one common carrier;
receiving at said first computer from said at least one common carrier, data related to travel services provided by said common carrier;
correlating data related to travel services provided by said common carrier, to the travel requirements of said traveler.

6. The method of claim 1 wherein said step of transmitting at least a portion of said first set of data to said traveler via said data network is further comprised of the steps of:
sending to an output device that is remotely located from said first computer via said data network, a first set of travel-related data that is related to and particularly associated with at least one destination to which said traveler intends to travel to.

7. The method of claim 1 wherein said step of transmitting at least a portion of said first set of travel data is further comprised of the steps of:
sending to a printer device, which is remotely located from and coupled to said first computer via said data network, a first set of travel data that is related to and particularly associated with at least one destination to which said traveler intends to travel to.

8. The method of claim 1 wherein said step of transmitting at least a portion of said first set of travel data is further comprised of the steps of:
sending to a printer device, which is remotely located from and coupled to said first computer via said data network, and proximate to said traveler, data from which printed entertainment material for consumption by said traveler is output from said printer device.

9. The method of claim 1 wherein said step of transmitting at least a portion of said first set of data is further comprised of the steps of:
sending to a common carrier via said data network, said first set of travel data related to and particularly associated with at least one destination to which said traveler intends to travel to.

10. The method of claim 9 wherein said step of sending to a common carrier via said data network, said first set of travel data includes the step of sending to a printer of said common carrier via said data network, said first set of travel data related to and particularly associated with at least one destination to which said traveler intends to travel to.

11. The method of claim 1 wherein said step of transmitting at least a portion of said first set of data is further comprised of the steps of:
sending to a personal digital assistant device via said data network, said first set of data related to and particularly associated with at least one destination to which said traveler intends to travel to.

12. The method of claim 9 further including the step of directing said first set of data to a printer coupled to said personal digital assistant.

13. The method of claim 6 wherein said first set of travel data and information includes at least one of:
a. service schedule data and information for at least one common carrier;
b. advertising data and information;
c. local meteorological data and information;
d. local geographic data and information;
e. local demographic data and information;
f. local lodging and accommodation data and information;
g. local dining data and information;
h. local entertainment data and information;
i. ground transportation providers;
j. local cultural and topical data and information;
k. educational institutions;
l. local shopping data and information;
m. local professional sports franchise data and information;
for at least one destination of said traveler.

14. The method of claim 6 wherein said first set of data includes at least one of:
a. entertainment material for said traveler;
b. at least portions of a publication for consumption by said traveler, said portions of a publication conforming to a user profile by which content information of interest to said traveler is selected;
c. advertising material.

15. The method of claim 1 wherein said step of transmitting said first set of travel data includes the step of transmitting said data via the Hewlett-Packard Instant Delivery service.

16. The method of claim 1 further including the step of downloading travel data at a remote terminal facility.

17. The method of claim 1 further including the step of printing electronic tickets responsive to signals received at said first computer from said display device.

18. The method of claim 1 further including the step of outputting predetermined data signals from said display device as a secure key device.

19. The method of claim 1 further including the step of creating magnetic key cards from signals received at said display device.

20. The personal digital assistant of claim 10 wherein personal digital assistant is comprised of a display device, capable of displaying scrolling information in at least one predetermined region of said display and input device in response to information signals coupled into said display and input device.

21. The personal digital assistant of claim 10 wherein personal digital assistant is comprised of a display device, capable of a ticker-tape scrolling display of information in at least one predetermined region of said display and input device in response to information signals coupled into said display and input device.
